(19) United States
(12) Patent Application Publication
(10) Pub. No.: US 2022/0023943 A1
(43) Pub. Date: Jan. 27, 2022

(54) METHOD FOR TREATING AND EXAMINING A POWDER BY MEANS OF INSTRUMENTAL ANALYSIS AND USE

(71) Applicant: Industrieanlagen-Betriebsgesellschaft mbH, Ottobrunn (DE)

(72) Inventors: Tom Näke, Ottobrunn (DE); Marion Eiber, Ebersberg (DE)

(21) Appl. No.: 17/290,716

(22) PCT Filed: Oct. 30, 2019
(86) PCT No.: PCT/EP2019/079681

§ 371 Date: Apr. 30, 2021

(51) Int. Cl. B22F 1/00; G01N 23/046; G01N 23/2251; B33Y 40/10; B33Y 70/00

(52) U.S. Cl. CPC B22F 1/0088; G01N 23/046; B22F 1/0003; G01N 23/2251; B33Y 40/10; B33Y 70/00; G01N 2223/66; B22F 2203/03; G01N 2223/62; G01N 2223/419; G01N 2223/418; G01N 2223/641; B22F 2999/00

(57) ABSTRACT

The application relates to a method for treating and examining a powder by: generating two-dimensional tomographic representation of an initial small amount of powder granules of the powder; determining and outputting an initial powder granule structural parameter based on the two-dimensional tomographic representation of the initial small amount of powder; producing a solid body including a statistically validatable powder representation of a totality of the powder granules of the powder; tomographically representing the solid body, wherein at least one imaging parameter and/or at least one image recording setting is adjusted based on the initial powder granule structural parameter; and determining and outputting at least one characteristic value of the statistically validatable powder representation of the powder granules of the powder by evaluating the tomographic representation of the solid body.

The present invention relates to a method for treating and examining a powder by means of instrumental analysis which comprises production of a solid body and a use of a solid body.

Methods for treating and examining powders by means of instrumental analysis are known from the prior art.

For example, Mostafaei et al. 2018 described characterization methods for nickel-based alloy powders as used in the field of additive manufacturing processes (3D printing processes). The characterization processes thereby described are labor-intensive and thus cost-intensive.

The task of the invention is that of providing a method for treating and examining powder by means of instrumental analysis which is efficient in terms of time, labor and costs and which is able to be performed in simplified manner and provides an improved analysis.

This technical problem is solved in particular by a method comprising the steps according to claim 1.

In particular, the task is solved by a method for treating and examining a powder by means of instrumental analysis which comprises the steps of:
generating at least one two-dimensional graphic representation of an initial small amount of powder granules of the powder;
determining and outputting at least one initial powder granule structural parameter, particularly comprising a powder granule volume and/or powder granule sphericity and/or powder granule length, based on the at least one two-dimensional graphic representation of the initial small amount;
producing a solid body comprising a plurality of isolated and/or homogeneously distributed powder granules in the solid body distanced from other powder granules arranged in the solid body, wherein the totality of the powder granules arranged in the solid body is a statistically validatable powder representation of the totality of the powder granules of the powder;
graphically representing the solid body, in particular via computed tomography representation, wherein at least one imaging parameter and/or at least one image recording setting, in particular a sample position, is adjusted based on the at least one initial powder granular structural parameter;
determining and outputting at least one characteristic value of the statistically validatable powder representation of powder granules of the powder by evaluating the at least one graphic representation, particularly computed tomographic representation, of the solid body.

In a method of the above-described type, at least one parameter is assigned to a powder, particularly a powder in the scope of additive manufacturing (3D printing), which affords information about the applicability of the powder in or for one or more different manufacturing process(es), e.g. laser sintering, but in particular all other 3D printing processes in which powders are melted and/or remelted. In particular, direct information can be provided about the powder's process suitability (for example, the coater's applicative ability and/or the correlation of coat thickness to powder granule size). Preferably, the determined characteristic values form the basis for an evaluating of the digital volume as determined particularly by X-ray tomography/CT imaging processes.

“Particles” can particularly refer to powder granules of the powder to be examined and/or particularly foreign particles and/or particularly impurities and/or particularly sub-constituents of the powder which in particular do not correspond to at least 90% by weight (wt %) of the most common form of “particles” in the powder.

Particularly to be understood here by “two-dimensional graphic representation” is a generated two-dimensional view, particularly a top view and/or side view, of powder granules of an initial small amount. This at least one two-dimensional graphic representation can be a scanning electron micrograph and/or an atomic force microscopy (AFM) image and/or an X-ray image of the initial small amount and/or parts of the initial small amount. Further preferably understood are 2D sectional views, particularly based on CT processes, which in particular provide insight into at least one layer, particularly at least one powder granule, further particularly provide insight into at least one layer of a statistically evaluable amount of powder granules and/or a plurality of layers.

The two-dimensional graphic representation of the initial small amount can in particular comprise at least approximately 100 powder granules and/or at least approximately 50 powder granules and/or at most 500 powder granules and/or at most 1000 powder granules. Within the meaning of the invention, specifications in the present description which include “approximately” are to thereby particularly be understood as +/−10%, further particularly +/−20%, of the respective numerical value, albeit are in particular not claimed as being essential to the invention.

Preferably to be understood by an initial small amount is a volume of powder granules from the powder granules of the totality of the powder which in particular comprises at least approximately 100 powder granules and/or at least approximately 50 powder granules and/or at most 500 powder granules and/or at most 1000 powder granules.

Preferably, the powder granules depicted in the two-dimensional graphic representation, thus in particular the two-dimensional graphic representation of a portion of said powder granules, or the totality of the powder granules contained in the initial small amount respectively, are used and this two-dimensional graphic representation of said powder granules analyzed in order to determine and output at least one initial powder granule structural parameter.

Preferably, at least one initial powder granule structural parameter can be a powder granule volume and/or in particular a powder granule sphericity, and/or in particular a powder granule length and/or in particular a powder granule ellipticity, particularly a layer view, a 2D sectional view and/or particularly a powder granule agglomeration parameter, further particularly the at least one initial powder granule structural parameter can be a topography parameter and/or in particular a morphology parameter and/or in particular an (element) composition parameter and/or in particular a material contrast parameter.

A core concept of the invention is the production of a solid body in which a plurality of powder granules are arranged such that the majority of the powder granules in the solid body are distanced from the surrounding powder granules in the solid body, particularly distanced such that the surface of the individual powder granules in the solid body is readily accessible, in particular readily accessible for at least one further graphic representation and/or at least one graphic examination.

A solid body within the meaning of the invention is in particular an actual body, thus a body existing in physical reality, which is in particular able to be subjected to physical and/or chemical examinations. The solid body can thereby be made of plastic and/or resin and/or adhesive and/or polymer matrices, further particularly made of two-component resin and/or a comparable compound and/or compoundable substance. The solid body is in particular not a workpiece, particularly not a workpiece produced via a “top-down approach,” thus in particular not a workpiece resulting from carving a body out of a larger solid body. In particular not to be understood as a solid body in the sense of the present invention is a digital body, thus a body without an actual form; i.e. a form existing in physical reality.

The distribution of the plurality of powder granules in the solid body is preferably homogeneous such that the solid body thus in particular has the same powder granule density over the entire solid body. The powder granule density is thereby in particular at least approximately 0.1 powder granule per cubic millimeter (mm³) and/or at least approximately 2 powder granules per cubic millimeter and/or at least approximately 40 powder granules per cubic millimeter and/or at most approximately 800 powder granules per cubic millimeter and/or at most approximately 16,000 powder granules per cubic millimeter. Homogeneous in this context is in particular to be understood as the above-described powder granule density in the solid body remaining the same over the entire solid body, the solid body thus in particular not having any appreciable higher density and/or appreciable lower density areas. “Appreciable” is thereby in particular to be understood similarly to “approximately,” particularly as previously defined.

Preferably, “isolated” is synonymous with distanced in the context of the present invention and to be understood as such. It is further particularly to be understood that the powder granules are isolated particularly in at least predominantly all directions of the body, thus in particular distanced from each other particularly in at least predominantly one of the main geometric axes of the solid body. The main geometric axes of the solid body are thereby in particular to be understood as the main axes of rotation and/or of symmetry and/or the longest and/or shortest axis through the body. Minor axes are preferably those axes not constituting any main axes in the sense of the definition provided here.

Preferably, the plurality of powder granules in the solid body is a “statistically validatable powder representation,” thus in particular a volume of powder granules providing conclusions as to the properties of the totality of the powder granules in the powder, particularly the properties of the totality of the powder granules in the entire batch of powder, subsequent statistical analysis. A statistically validatable powder representation comprises in particular at least 100 powder granules and/or at least 1000 and/or at most 1,000,000 powder granules and/or in particular no more than 10,000,000 powder granules.

It is possible to introduce approximately 1 g of powder in total into the body as a mass. The invention is not limited thereto. Far larger masses are possible since only a section of the sample or respectively body is examined.

Preferably, the solid body is represented graphically, particularly by means of at least one three-dimensional graphic representation. A graphic representation, particularly a three-dimensional graphic representation as defined by the invention, can in particular be a computed tomographic graphic representation and/or a magnetic resonance tomographic representation and/or a three-dimensional graphic representation based on 3D image synthesis from 2D sample sectional views, a so-called 3D imaging process.

The solid body is preferably imaged in a 3D imaging process. Preferably, 2D sample sectional views are first generated by rotating the solid body in an appropriate imaging device, further particularly 2D body sections are imaged. 2D body sections in this context are to be understood as thin-layer sections, particularly of a few micrometers (μm) in thickness, further particularly smaller than 5 μm and/or smaller than 2 μm and/or not larger than 20 μm of the three-dimensional solid body. In particular, these two-dimensional partial graphic representations of the solid body are then subsequently merged into a three-dimensional image, particularly by means of computer-aided 3D image synthesis, whereby a digital volume of the three-dimensional solid body is in particular formed.

Preferably, at least one imaging parameter and/or at least one image recording setting is/are adjusted based on the at least one initial powder granule structural parameter. “Adjusting an imaging parameter” is thereby in particular to be understood as adjusting an image resolution and/or image generation resolution and/or a contrast setting and/or an acquisition time. “Adjusting an image recording setting” is thereby in particular to be understood as adjusting a position of the solid body and/or an alignment of the solid body and/or an orientation of the solid body, in particular relative to and/or in the apparatus for generating the graphic representation of the solid body, further particularly relative to a focal plane for generating the graphic representation of the solid body in the respective apparatus. The position of a source and/or a detection device is furthermore in particular adjusted.

In one embodiment, the method is such that at least one macroscopic powder parameter is determined, in particular piling behavior and/or at least one coloration of the powder. This thereby improves the powder examination.

Piling behavior, particularly a Hausner factor and/or at least one coloration and/or a contrast and/or a color gradient of the powder can be determined as a macroscopic powder parameter. Preferably, granularity and/or a powder granule size distribution, further preferably a macroscopic reduction state and/or oxidation state and/or contaminant state can be determined as the at least one macroscopic powder parameter.

In one embodiment, the method is such that at least one chemical component of the powder is determined. This thereby improves the powder examination.

Preferably, a chemical component of the powder is determined as an (element) composition of the powder and/or an oxidation state and/or in particular an oxide fraction and/or in particular a chemical fraction composition, further particularly at least one chemical contamination is determined and output as a chemical component.

In one embodiment, the method is such that the method comprises at least one process control point at which powder control parameters, in particular the macroscopic powder parameters and/or the identified chemical component, are provided for analysis and wherein the method is aborted or continued based on the result of the analysis. A method can thereby be terminated cost-effectively and/or expeditiously and/or at an early stage as applicable.

In the context of the application, a process control point is preferably a point within the course of the procedure, particularly at the end of a process step, when parameters, so-called powder control parameters, can be output at said point, whereby the process is continued or terminated, particularly by comparing the output powder control parameters to a powder control parameter database.

Preferably, the at least one macroscopic and/or the at least one chemical component is used as a powder control parameter, whereby the method is terminated and/or the method continued at the process control point, in particular the point in time at which the corresponding powder control parameters are obtained, based on the at least one macroscopic powder parameter and/or based on the at least one chemical component, particularly subsequent comparison of the at least one macroscopic powder parameter and/or the at least one chemical component to a database comprising at least one macroscopic powder parameter and/or at least one chemical component. In particular applicable is a database based particularly on the examination of comparable powders, in particular based on the examination of “equal” powders, particularly equal and/or similar powders from different batches, further particularly different partial volumes of a powder from one batch.

In one embodiment, the method is such that determining the macroscopic powder parameter includes an imaging process. A macroscopic powder parameter can thereby be readily determined and the powder examination improved.

A photographic imaging process and/or a light microscopic imaging process and/or a video recording process is preferably used as the imaging process for determining the macroscopic powder parameters in the inventive method. Further preferentially, at least one macroscopic powder parameter is determined from the listed imaging processes, particularly in a computer-assisted, in particular fully automated manner, and output. Electron microscopy and/or AFM microscopy are in particular not used in the sense of an imaging process for determining the macroscopic powder parameter.

In one embodiment, the method is such that chemical and/or physical and/or geometric parameters are determined on the basis of imaging process and, where applicable, stored. So doing improves the examination of the powder.

An oxidation parameter and/or a corrosion parameter is/are preferably determined and, where applicable, output as a chemical parameter. Further preferentially, powder density parameters and/or in particular moisture parameters and/or in particular macroscopically detectable powder structural parameters are determined and, where applicable, output as physical parameters. Further preferentially, in particular a powder granularity parameter and/or in particular a powder granule morphology parameter and/or in particular a coarse/fine granularity parameter are output as geometric parameters.

The method is preferably such that the chemical and/or physical and/or geometric parameters are powder control parameters. A method can thereby be terminated cost-effectively and/or expeditiously and/or at an early stage as applicable.

At least one chemical and/or physical and/or geometric parameter is preferably used as the powder control parameter, whereby the method is terminated and/or the method continued at the process control point, in particular the point in time at which the corresponding powder control parameters are obtained, based on at least one chemical and/or at least one physical and/or at least one geometric parameter, particularly subsequent comparison of the at least one chemical and/or at least one physical and/or at least one geometric parameter to a database comprising at least one chemical and/or at least one physical and/or at least one geometric parameter, in particular a database as previously defined.

In one embodiment, the method is such that the powder is at least temporarily converted into liquid form for a chemical treatment and/or a chemical analysis. This simplifies the implementing of the method.

In the context of the invention, “temporarily” is preferably to be understood as the powder being converted into a liquid form for the course of the chemical treatment and/or the chemical analysis, in particular converted into liquid form by melting and/or fusion melting. Further preferentially, a chemical treatment and/or a chemical analysis is performed on a solid body resulting from the liquid form, in particular a melt and/or fusion melt, particularly a solid, further particularly a single-piece solid body, further particularly a flat solid body, thus in particular no longer on a powder.

In one embodiment, the method is such that a disintegrant is added to the powder before it is at least temporarily converted into a liquid form. This simplifies the implementing of the method.

A disintegrant, particularly lithium tetraborate, is preferably added to the powder, in particular prior to it transitioning into a liquid form, particularly a fusion melt.

In one embodiment, the method is such that the chemical components are simultaneously measured while said chemical components are being determined. This simplifies the implementing of the method.

Preferably, the content of all chemical elements having a higher atomic number than that of Na is qualitatively and quantitatively determined, particularly with a detection limit and/or measurement accuracy of in particular at least 1 ppm and/or at least 3 ppm and/or at most 20 ppm/or at most 50 ppm. The detection limit and/or measurement accuracy is/are thereby particularly element-dependent and the maximum values are in particular to be understood here as the lowest possible detection limit and/or measurement accuracy for at least one of the elements.

Further preferably, the chemical components, in particular the chemical elements contained in the powder, in particular all detectable chemical elements, are determined simultaneously, thus in particular at the same time. This is particularly to be understood as only one method step being used in order to determine the content of all the detectable elements in the powder, in particular all the elements with an atomic number greater than that of Na.

Particularly the chemical components, in particular the chemical (element) composition, can act as a powder control parameter.

In one embodiment, the method is such that the chemical analysis comprises a determination of the powder's water content. This improves the examination of the powder.

The water content of the powder is preferably determined in weight percentage, further preferentially in ppm. Further preferentially, the powder sample is heated in a furnace and conveyed in particular via a gas line into a reagent, particularly a Karl Fischer reagent. Preferentially, the water content is subject to a detection limit and/or measurement accuracy of at least 20 ppm and/or a detection limit and/or measurement accuracy of at least 10 ppm and/or at most 30 ppm. “At most” is to be understood here as constituting an upper numerical value of a lower detectability range limit for the water content of the powder.

The water content can in particular act as a powder control parameter.

In one embodiment, the method is such that the chemical analysis comprises determination of non-metallic content. This affords the aforementioned advantages.

Further preferentially, the content of non-metals within the powder is determined, in particular C, S, O, N and H. In particular, the content of the C, S, O, N and H non-metals is conducted based on alloy-dependent standards; particularly for titanium alloys, these being ASTM E1409-13, ASTM E1447-09, ASTM E1941-10. Preferentially, the powder sample is inductively heated in a gas flow, in particular inductively heated above the melting temperature, and the resulting gases released quantified for their non-metal content, in particular quantified at a detection limit and/or measurement accuracy of at least 1 ppm and/or at least 2 ppm and or at most 5 ppm. “At most” is to be understood here as previously defined.

Preferably, unknown powder components are determined by the determining of non-metallic content.

The non-metal content can in particular act as a powder control parameter.

In one embodiment, the method is such that the step of chemical treatment and chemical examination includes a spectroscopic analysis.

Preferably performed is a spectroscopic analysis, in particular an X-ray fluorescence analysis, particularly an absorption spectroscopic analysis, further particularly nuclear magnetic resonance (NMR) spectroscopy.

An X-ray fluorescence analysis is preferably conducted pursuant to DIN 51418, particularly on a sample generated after fusion melting.

In one embodiment, the method is such that an initial small amount of at least approximately 50 powder granules and/or at least approximately 100 powder granules and/or at most approximately 500 powder granules and/or at most approximately 1000 powder granules is involved. “Approximately” is to be understood here as previously defined.

In one embodiment, the method is such that the two-dimensional graphic representation is realized on at least one predominantly two-dimensional preparation of the initial small amount of the powder granules of the powder.

A “predominantly two-dimensional preparation” within the meaning of the invention is in particular to be understood as a monolayer, thus in particular consisting of only a single layer of powder granules and/or particles from the powder, in particular on an appropriate substrate, particularly an adhesive carbon pad.

Preferentially, in particular more than 90% by weight of the two-dimensional preparation to be examined is provided as a monolayer of powder granules and/or particles from the powder, particularly on a substrate element.

Further preferentially, the substrate element is an adhesive carbon pad.

In one embodiment, the method is such that the two-dimensional graphic representation is at least one magnified image representation of the powder granules of the initial small amount, which affords the previously specified advantages.

Preferably, a magnified image representation in the sense of the invention is a (scanning) electron microscopic representation, particularly a graphic representation in the form of an (electron microscopic) single-particle analysis and/or AFM microscopic image representation.

Magnifications of 50:1 to 20,000:1 are further preferential. The maximum magnification amounts to 50,000:1.

In particular not used within the meaning of the invention are light microscopic magnified image representations of the initial small amount.

In one embodiment, the method is such that, based on the at least one magnified image representation, form parameters and/or state parameters of the powder granules are obtained as initial powder granule structural parameter(s). An examination method is thereby improved accordingly.

Particularly powder granule geometric parameters and/or surface quality parameters and/or volume estimation parameters are preferably obtained as form parameters.

Particles which adhere to larger powder granules in a direct volume comparison are referred to as satellites.

Agglomerates are defined as powder particles adhered to one another albeit not in flush connection.

Preferably obtained as state parameters are in particular satellite concentrations and/or satellite occurrence probabilities and/or satellites per powder granule, further particularly agglomerate quantities and/or agglomerate sizes, in particular over the average amount of agglomerated powder granules, and/or free powder granules per agglomerated powder granules and/or adhesion behavior parameters.

In one embodiment, the method is such that the two-dimensional graphic representation comprises a chemical component determination occurring simultaneously with the two-dimensional graphic representation. This enables the easy implementing of the method.

Within the meaning of the invention, “simultaneous” is to be understood as described above. Preferably, the chemical component determination takes place in particular at the same time, further particularly throughout the entire method step of obtaining the two-dimensional graphic representation, in particular overlaps in time with part of the recording of the two-dimensional graphic representation.

Particularly a micro-area analysis is preferably performed as the chemical component determination, in particular up to an element-specific detection limit of at least 0.3 mass percent and/or at least 0.5 mass percent and/or at most 1 mass percent. “At most” is thereby to be understood as constituting the largest numerical value of a lower detection limit.

In one embodiment, the method is such that impurities are extracted from the powder in the method and the extract and/or the purified powder examined, particularly by weighing, further particularly by scanning electron microscopy. A method and an examination of the powder is thereby improved.

Extraction is preferably to be understood as an in particular mechanical separation, further particularly a density-dependent separation, further particularly a magnetic interaction-based separation, thus in particular a separation of magnetic vs. non-magnetic components, further particularly a separation based on chemical purity, further particularly based on trend procedures capable of separating noble chemical elements from base chemical elements.

Further preferentially, the purified powder and/or the extract is weighed and a weight ratio formed therefrom which acts in particular as a powder control parameter.

Further preferentially, the extract and/or the powder is made available to an electron microscope imaging process step.

In one embodiment, the method is such that the extract of impurities is examined as per the examinations applied to the powder or parts of the examinations or one part of the examinations or at least a part of at least one of the examinations, in particular by means of two-dimensional graphic representation, whereby purification parameters can be determined.

Preferably, the extract is subject to the examinations applied to the powder, in particular specific parts of the procedural steps, particularly a chemical analysis and/or a physical analysis and/or a further purification, further particularly undergoes at least one two-dimensional graphic representation and corresponding analysis.

Further preferably, the extract is subject to only some of the examinations, thus in particular not all of the method's procedural steps.

Further preferably, the extract is subject to at least part of at least one of the procedural steps.

Particularly chemical components and/or the change in chemical components compared to the non-purified form are preferably output as a purification parameter; the content of non-metals and/or the element composition and/or oxidation and/or corrosion parameters are in particular determined and, where applicable, output.

Further preferentially, state parameters and/or form parameters and/or spectroscopic parameters, particularly absorption and/or X-ray fluorescence and/or a spectrum, are determined as a purification parameter and, where applicable, output.

In one embodiment, the method is such that at least one step of the method is repeated. This allows a more precise rendering of the examination.

Preferably, a powder sample, particularly in the form of a small amount and/or the form of a statistically validatable powder representation, is returned back to a previous step of the method, in particular at a process control point, further particularly post-purification, and at least this step of the method repeated.

In one embodiment, the method is such that the purification parameters are used to purify the powder. This improves the powder treatment.

The powder is preferably purified as described above. Further preferably, the powder can be purified particularly by utilizing chemical reactions and/or chemical purification. In particular, chemical reactions for purifying the powder can be redox reactions and/or oxidations and/or reductions.

The purification parameters are preferably used to purify the powder, thus in particular to quantify and/or qualify a purification result. Further particularly, the purification parameters are used to further purify the powder if indicated; i.e. given an inadequate purification result, using recursion and/or repetition of specific procedural and/or purification steps to further improve the purification. The purification parameters, particularly the powder control parameters, preferably serve as an evaluation of the purification quality, in particular quantitatively and/or qualitatively.

In one embodiment, the method is such that a statistically validatable powder representation comprises at least 100 powder granules and/or at least 1000 and/or at most 1,000,000 powder granules and/or in particular no more than 10,000,000 powder granules. This enables improved examination of the powder.

In one embodiment, the method is such that the solid body is formed from plastic. This improves an examining/examination of the powder.

The solid body is preferably made of plastic, in particular resin, further particularly made of a two-component plastic/resin. Further particularly, the solid body can be designed so as to temporarily be a solid body, particularly being a solid body over the time the method is being carried out.

In one embodiment, the method is such that during the production of the solid body, ultrasound acts upon at least one precursor stage of the solid body. This enables the particles to be isolated in the solid body and thus analyzed in isolation from interactions with other particles. This improves an examining/examination of the powder.

The precursor stage is preferably liquid, in particular a bath and/or a melt. Further preferentially, the precursor stage is in particular a component of a two-component plastic in its liquid form. Further particular, the precursor stage is a viscous mass.

The application of ultrasound preferably takes place while the precursor stage is in liquid form, thus in particular at a time during which the precursor stage is in liquid form. The application of ultrasound to the liquid precursor stage preferably proceeds until the powder granules are isolated and/or homogeneously distributed in the liquid and/or viscous precursor stage. Further preferentially, the application of ultrasound is terminated and/or disabled upon the powder granules isolating and/or homogenizing in the liquid and/or viscous precursor stage and particularly when reagglomeration and agglomeration of the particles occurs more slowly than a transition of the liquid and/or viscous precursor stage into a solid body.

In one embodiment, the method is such that during the production of the solid body, ultrasound acts upon the precursor stage at a time during which the precursor stage is forming into a solid body. This improves an examining/examination of the powder.

During the production of the solid body, ultrasound preferably acts upon the precursor stage particularly at a time during which the precursor stage forms into a solid body, in particular while the precursor stage of the solid body is forming into a solid body over time, it is acted upon by ultrasound. The application of ultrasound in particular begins at a time while the precursor stage is still in a liquid and/or viscous state and in particular ends with the nearly completed formation of a solid body. To in particular be understood by a completed formation of a solid body is when the particles introduced into the precursor stage and in particular isolated and homogenized by means of ultrasound no longer have sufficient freedom of movement to form agglomerates and/or clump together. A point in time and/or a course of time and/or a time-modulated course is in particular also to be understood by “application time.”

The production of the solid body is preferably constructed such that the chemical and/or physical characteristic values are not altered.

Further particularly, the production of the solid body ensues such that powder particles are not destroyed and/or damaged and/or appreciably altered. Further particularly, a surface property and/or a volume and/or a satellite association is not thereby modified.

In one preferential embodiment, the method is such that the graphic representation of the solid body is based on 3D imaging (corresponding to a 3D imaging process).

In one embodiment, the method is such that the solid body is not altered by 3D imaging. This improves an examining/examination of the powder.

Further preferentially, the 3D imaging is non-destructive to the solid body and the particles and/or powder granules arranged therein. In particular, the physical and/or chemical properties of the body and the particles and/or powder granules arranged therein are not altered by the 3D imaging. Further particularly, the 3D imaging and/or measurements on the solid body do not impact the arrangement of the particles and/or powder granules in the solid body. Preferably, the steps used in the method, thus in particular with respect to the solid body, are repeatable method steps, particularly more than 10×, further particularly more than 100×, without effecting damage to the solid body and/or the particles and/or powder granules arranged therein and/or altering its chemical and/or physical properties.

The method is preferably such that the solid body is at least substantially a cylinder or at least substantially a sphere or at least substantially a cuboid or at least substantially a cube.

In the context of the present invention, “at least substantially a cylinder/sphere/cuboid/cube” is to be understood as the resulting geometric solid body deviating from the dimensions of an ideal cylinder/sphere/cuboid/cube in the mathematical sense by less than 30%, and/or in particular less than 20%, and/or further particularly less than 10%, and/or however no more than 50%, particularly with respect to the edge lengths and/or particularly the edge length ratios and/or particularly the surface areas and/or particularly the area ratios and/or particularly the angles and/or particularly the angular ratios and/or particularly the sphericity.

In particular, the solid body is a cylinder of at least 1 mm in diameter, further particularly 10 mm in diameter, further particularly at most 30 mm in diameter and/or at most 60 mm in diameter, further particularly at most 50 mm in diameter, further particularly at most 40 mm in diameter; further particularly at most 100 mm in height, particularly at most 80 mm in height, further particularly at most 50 mm in height and/or particularly at least 1 mm in height, further particularly at least 10 mm in height, in particular at least 40 mm in height.

Geometric shapes deviating from a cylinder, particularly spheres/cuboids/cubes, are preferably dimensioned so as to have a volume corresponding to that of the above-described cylinder.

In one embodiment, the method is such that the 3D imaging comprises the creation of a digital volume of the body. This improves an examining/examination of the powder.

Preferably, a digital volume of the solid body, thus a digital image of the actual physical solid body, is implemented. The digital volume in particular exhibits a digital representation of the particles and/or powder granules, whereby particularly the relative positions of the particles and/or powder granules remain intact in the digital volume when compared to the actual physical solid body.

In one embodiment, the method is such that at least one powder granule structural parameter is at least one particle size and at least one 3D imaging parameter is a detection resolution. This improves an examining/examination of the powder.

Preferably, the particle size is smaller than approximately 1000 μm and/or smaller than approximately 200 μm and/or smaller than 100 μm, further particularly larger than approximately 1 μm and/or larger than 10 μm and/or larger than 25 μm. Here as well, “approximately” is to be understood as previously defined.

Detection resolution is preferably used as the 3D imaging parameter. In particular, high-resolution computed tomography (CT) is conducted, particularly also micro-CT (μCT). To thereby in particular be achieved are resolutions of approximately less than 100 μm, further particularly in the resolution range of less than approximately 30 μm and/or less than approximately 20 μm, particularly preferably less than approximately 10 μm and/or less than approximately 5 μm, further particularly preferentially less than approximately 1 μm, in particular no more than approximately 150 μm and/or approximately 200 μm. Particularly essential to achieving a resolution sufficient for the inventive method is a precise adjustment and/or alignment of the individual system components and/or the sample, particularly the solid body as a sample, in particular relative to the detection device and/or to the source. Particularly the X-ray tube and/or the detector and/or the rotational axis of the sample are to be understood as being system components. Further particularly, the rotational axis of the sample can be a main axis, particularly as previously defined, and/or a minor axis, particularly as previously defined. Here as well, “approximately” is to be understood as previously defined.

Further particularly, a CT retardation spectrum, in particular corresponding to a (central) wavelength of the emitted photons, is adjusted for the resolution to be achieved.

Further preferably, a CT source setting, in particular an energy and/or an output and/or an exposure period and/or a wavelength, is adjusted for the resolution to be achieved.

Preferably, the particle/powder granule sizes represent input variables for achieving a resolution for the (CT) examination as needed to realize the method. Further particularly, morphology statements (on the particles/powder granules) form the basis for the limit values and/or tolerances to be set for the volume assessment (in particular of a digital volume) in terms of form factors and/or sphericity. In particular, the powder granule structural parameters as determined are drawn on to determine and/or record and/or generate evaluation parameters for the further method steps, particularly for the creating and/or evaluating of a graphic representation of the solid body and/or a corresponding digital volume.

In one embodiment, the method is such that at least one powder granule structural parameter is an absorption behavior and at least one 3D imaging parameter is a source setting. This improves an examining/examination of the powder.

Preferably, the absorption behavior of the powder and/or the initial small amount and/or a representative large amount is to in particular be understood as a representative amount corresponding to a statistically validatable powder representation as previously defined, and/or portions and/or individual components of the powder and/or the initial small amount and/or the representative large amount.

Further preferably, a (CT) source setting is an energy and/or an output and/or an exposure period and/or imaging period and/or a (central) wavelength and/or a frequency spectrum. In particular, a number of photons, further particularly an average number of photons, is adjusted, particularly to adjust pixel noise.

In one embodiment, the method is such that at least one characteristic value is a volume and/or a surface area and/or a length. This improves an examining/examination of the powder.

Preferably, at least one characteristic value is one of the following parameters and/or variables and/or ratios: particularly a particle size, in particular a particle size distribution, particularly at least one form factor (for example a sphericity), particularly a form factor distribution, in particular the hollow spaces in the particles, further particularly their number and/or their distribution and/or their density/number per particle, in particular the number and/or concentration and/or distribution of higher density particles (HDP), further particularly a particle density distribution, particularly a particle surface, particularly a particle surface distribution, particularly a particle length, particularly a particle volume.

The inventive method preferably comprises a macroscopy, a chemical analysis, a scanning electron microscopic examination, the production of a solid body and a computed tomography, further particularly the inventive method comprises only these steps and requires no further steps in order to attain the characteristic values of the powder.

The task is in particular also solved by a method for producing a solid body. In the process, powder granules of a statistically validatable powder representation are introduced into a precursor stage of the solid body, in particular a liquid precursor stage, and subsequently isolated or respectively distanced from other powder granules, particularly a statistically realizable powder representation introduced into the solid body in the precursor stage. In particular, the powder granules are distributed more homogeneously in the precursor stage; i.e. distributed at equal density in the precursor stage, whereby they are homogeneously distributed and/or isolated in the solid body particularly when the solid body is formed from the precursor stage. This spacing and/or isolation and/or homogenization occurs by way of isolating means, in particular dispersants and/or surfactants and/or ultrasound application and/or mechanical means, particularly agitating and/or stirring means. The chronological development and/or chronological progression of applying at least one active isolating means (under the effect of at least two isolating means) can ensue as previously described.

The task is in particular also solved by a method for treating and examining a powder by means of instrumental analysis, whereby for the production of a solid body having a plurality of isolated or homogeneous powder granules within said body which are distanced from surrounding powder granules, wherein the powder granules arranged in the solid body are a statistically validatable powder representation of powder granules of a powder, the method comprises the steps:
introducing the powder granules of the statistically validatable powder representation into a precursor stage of the solid body, in particular a liquid precursor stage;
isolating and distancing the powder granules of the statistically validatable powder representation from the surrounding powder granules of the statistically validatable powder representation and homogeneously distributed in the precursor stage by way of isolating means, in particular dispersants and/or surfactants and/or ultrasound application and/or mechanical means, particularly agitating and/or stirring means, acting on the powder granules introduced into the precursor stage;
fixing the position of the isolated powder granules of the statistically validatable powder representation by the transitioning or converting of the precursor stage of the solid body, comprising the isolated powder granules of the statistically validatable powder representation distanced from other powder granules of the statistically validatable powder representation and/or homogeneously distributed in the precursor stage of the statistically validatable powder representation, into a solid body;
graphically representing the solid body, particularly via computed tomographic representation;
determining and outputting at least one characteristic value of the statistically validatable powder representation of powder granules of the powder by evaluating the at least one graphic representation, particularly computed tomographic representation, of the solid body.

Preferably, the isolating and/or spacing and/or homogenization in particular occurs simultaneously with the fixation, thus in particular simultaneously with the formation of the solid body from the precursor stage. Further particularly, the isolating means only acts on the precursor stage of the solid body; the isolating means in particular acts on the precursor stage and the solid body being formed. The action of the isolating means at a given time is thereby to be understood as a point in time, thus in particular a short-term action, in particular until isolation and/or homogenization of the particles has occurred. Particularly when a reagglomeration of the particles proceeds faster than formation into a solid body from a precursor stage, the isolating means can in particular act simultaneously over a course of time, in particular a long and/or longer period of time, particularly over the entire period of time for formation of the precursor stage of the solid body into a solid body.

Preferably, one and/or more isolating means can act in the manner as described above, in particular simultaneously and/or chronologically staggered, further particularly without overlapping in time and/or in particular overlapping during part of the time. Further preferentially, the formation of the solid body can in particular occur spontaneously, particularly via a passive drying process. Further particularly, the formation of a solid body can be initiated particularly by an active drying process, in particular a heat-supported and/or cooling-supported drying process. Further particularly, curing can be initiated by and result from the addition of a primer and/or a reaction starter. This corresponds in particular to an active chemical start. Further particularly, an active physical start can occur, in particular a mixing process, particularly by mixing a first component with a second component. The formation of a solid body can in particular also occur actively via the action of mechanical means. Further particularly, there can also be a mixture of the different active start processes.

Further particularly, the task of the invention is solved by the use of a body having a plurality of powder granules of a statistically validatable powder representation of powder granules of a powder present in the body, particularly for use in a method for treating and examining a powder by means of instrumental analysis.

Further embodiments of the invention are yielded by the subclaims.

The invention will be described in greater detail in the following on the basis of an exemplary embodiment referencing the figures. Thereby shown are:

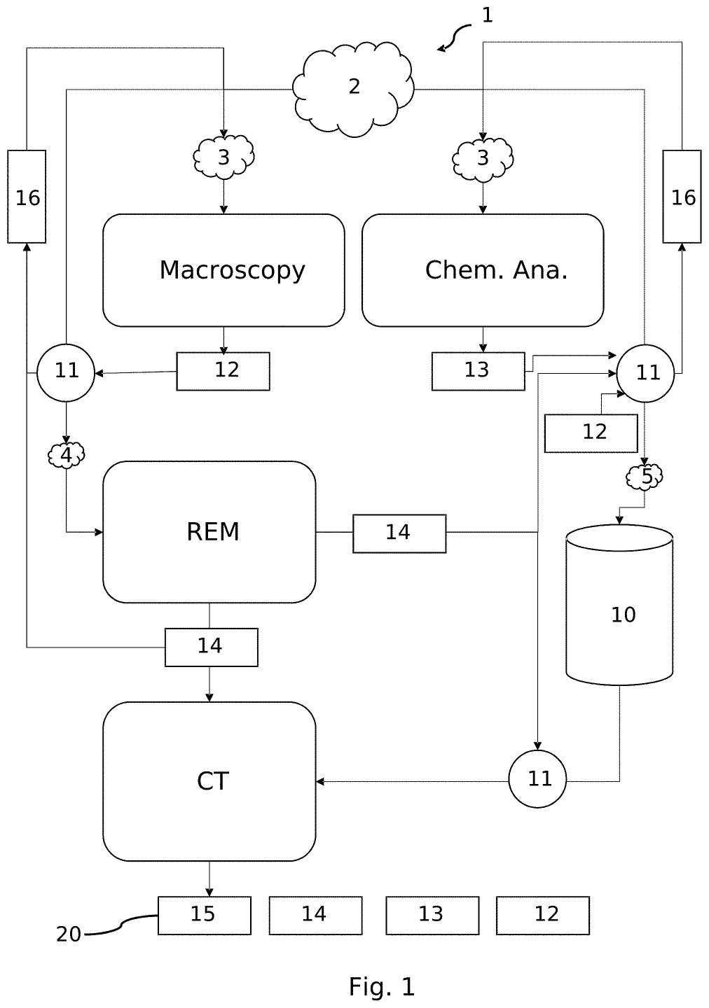

FIG. 1 a schematic representation of a method for treating and examining a powder by means of instrumental analysis

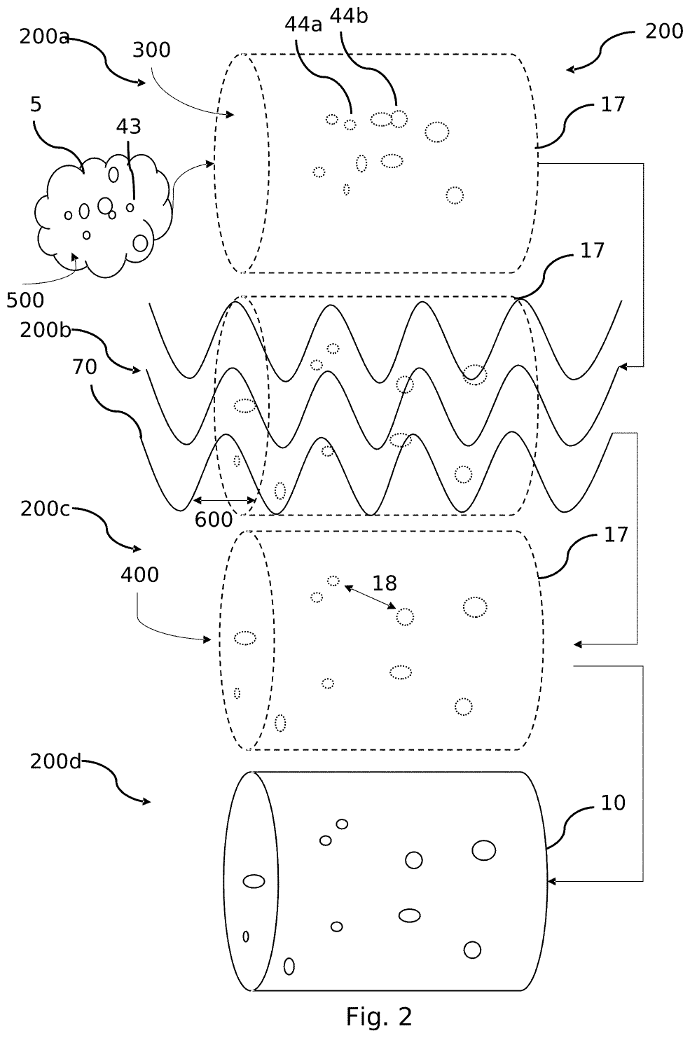

FIG. 2 a schematic representation of a method for producing a solid body

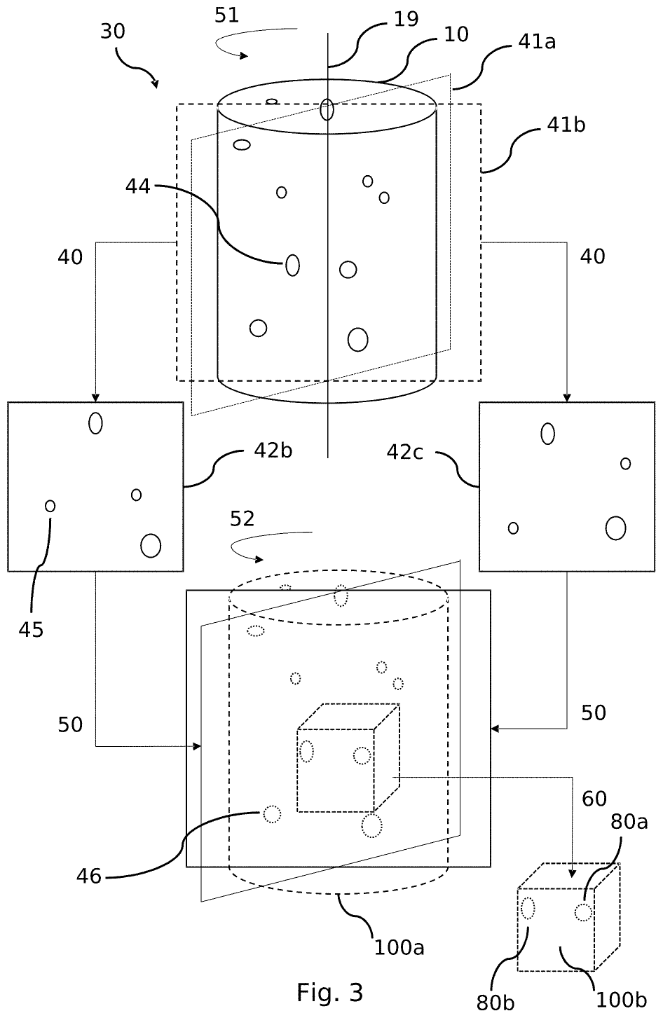

FIG. 3 a 2D sectional image extraction and 3D image synthesis based on 2D sectional views for creating a digital volume and selecting a partial volume of the digital volume

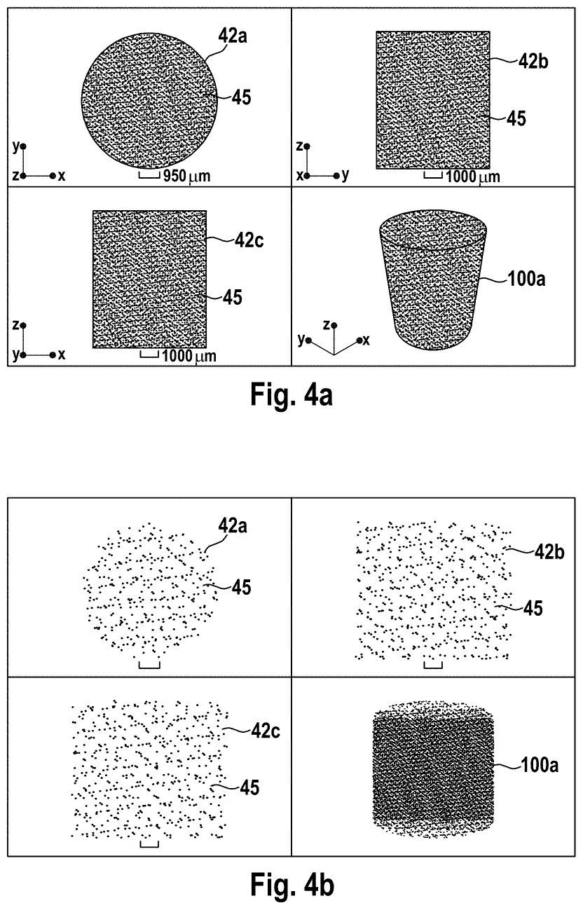

FIG. 4a an overview of 2D sectional views and resulting digital volume of a solid body according to a prior art method

FIG. 4b an overview of 2D sectional views and resulting digital volume of a solid body according to a method pursuant to the invention

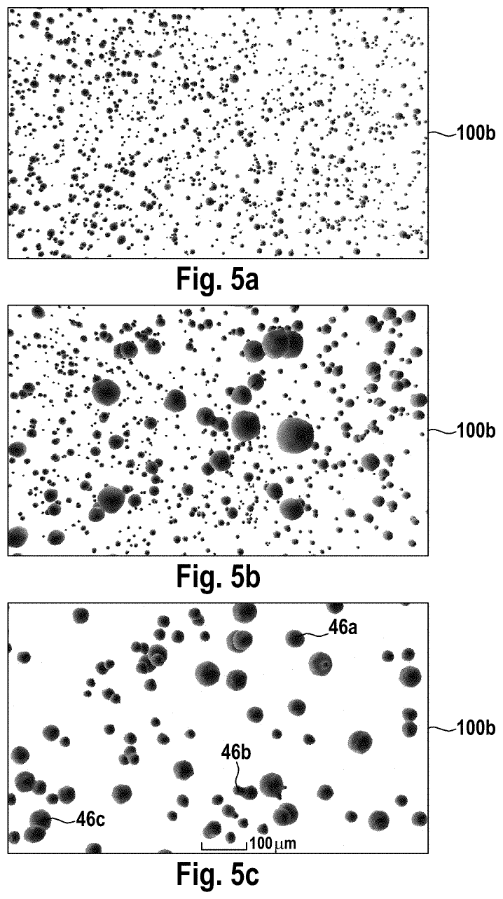

FIG. 5 an overview of different partial digital volumes of a digital volume of a solid body according to a method pursuant to the invention

FIG. 5a a large partial digital volume

FIG. 5b a medium-sized partial digital volume

FIG. 5c a small partial digital volume

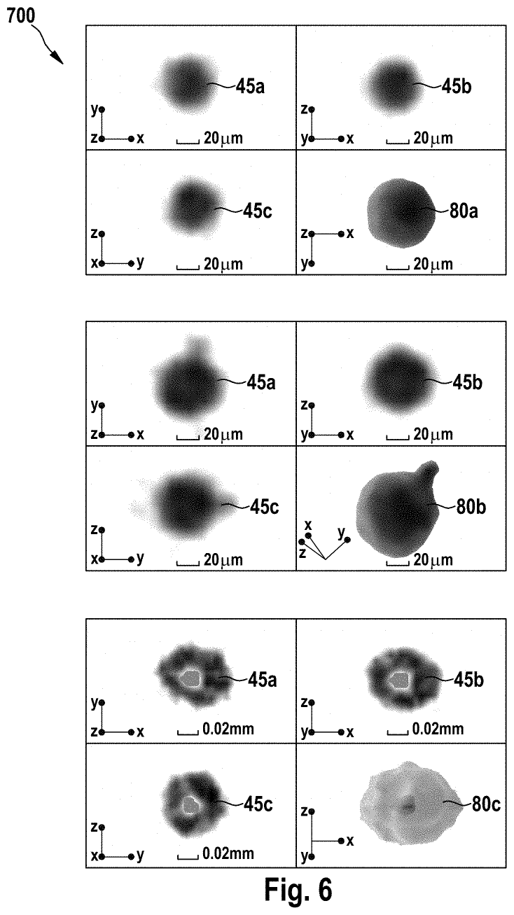

FIG. 6 3D image synthesis of isolated powder granules

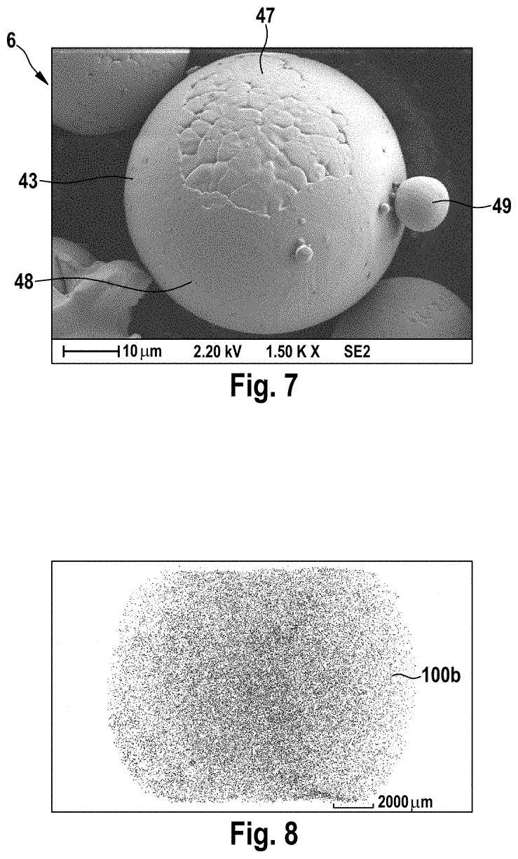

FIG. 7 a scanning electron microscope (SEM) image of a 2D powder granule preparation

FIG. 8 a partial digital volume corresponding to a thin cross-section perpendicular to the rotational axis of the solid body of 10 mm in diameter

The following description uses the same reference numerals for components of equal and equivalent effect.

FIG. 1 shows a schematic representation of a method 1 for treating and examining a metallic/metal alloy-based powder by means of instrumental analysis according to one inventive exemplary embodiment. The method is applicable for imaging all metals. The densities thereby correspond to ordinary metals from magnesium (1.7 g/cm³) to medium (22.6 g/cm³) and/or generally larger 1.5 g/cm³.

Commercially available powders with a mean particle size between 10 and 100 μm can thereby be treated and examined.

A powder sample 3; i.e. a small amount of the powder, is drawn from the totality of the powder 2 for examination by means of macroscopic and chemical analysis. Said powder sample 3 is supplied to the macroscopic and/or chemical analysis. The chemical analysis yields the chemical components 13 which are present in the powder, or of which the powder partially consists respectively, including the non-metal content (N, C, O, H), as well as an oxide content. To that end, the powder of sample 3 is melted and solidified into a planar flat body and the planar flat body then subjected to X-ray fluorescence spectroscopic analysis. The macroscopy returns macroscopic powder parameters 12, including a Hausner factor, a degree of corrosion and a degree of oxidation. The completion of the macroscopy and/or the chemical analysis represents a process control point 11. When the chemical components 13 and/or macroscopic powder parameters 12 correspond to the specifications and/or indicate that the powder is capable of being processed, following comparison with a database, the method is continued.

Upon continuation of the method, an initial small amount 4 is drawn from the totality of the powder 2 and subjected to scanning electron microscopic examination. To that end, the particles of the initial small amount 4 are deposited onto an adhesive carbon pad and supplied to a scanning electron microscope (SEM). The scanning electron microscopic examination provides initial powder granule structural parameters, including initial sphericity, initial powder granule volume as well as initial powder granule length. The completion of the SEM examination represents another process control point at which the method is either continued or terminated based on the initial powder granule structural parameters. Upon continuation of the method, the initial powder granule structural parameters 14 are supplied to a computed tomography apparatus CT, whereby the measurement parameters and other settings of the computed tomography apparatus CT are adjusted based on the initial powder granule structural parameters 14 to the effect of the detector position and/or sample position and/or source settings altering for instance the emission power so as to minimize the noise and to maximize the resolution. The emission power, thus the number of photons emitted from the source, is optimized for implementing the computed tomographic method relative to the desired noise. As the noise increases, deviations in diameter and form values increase. Keeping the noise as low as possible for these values is therefore the goal. On the other hand, a desired resolution and thereby associated low noise competes with economical implementation of the method. For geometric dimensions such as for instance the powder granule diameter and/or powder granule length, a high resolution increases the measurement accuracy whereas it induces measurement deviations in form measurements such as sphericity. Therefore, the initial powder granule structural parameters are used for setting the computed tomographic apparatus CT so as to optimize the noise and the resolution for the examination of the respective powder. The settings and adjustments in the computed tomography apparatus ensue automatically.

Alternatively to terminating the method when the macroscopic powder parameters 12 and/or the chemical components 13 and/or the initial powder granule structural parameters 14 do not correspond to the specifications at a process control point 11 and/or would cause the method to be terminated after comparison with a corresponding database, the powder, the totality of the powder 2 and/or the powder sample 3 and/or initial small amount 4 and/or the statistically validatable powder representation 5 is supplied to a purification step 16. Sieving removes substances mechanically input into the powder but also oversized powder granules. These separated components of the powder are weighed and compared to the weight of the agitated powder in order to determine a degree of contamination. These impurities, or inputs and/or oversized powder granules respectively, are also supplied to the (not shown) method steps described here. The powder is thereafter fed back to macroscopic and/or chemical analysis again in order to re-determine the macroscopic powder parameters and/or chemical components and/or initial powder granule structural parameters. These parameters of the purified powder determine the continuation and/or termination and/or a further purification step of the method at process control point 11. This thereby yields a recursive opportunity for further purifying the powder until ultimately positively passing the process control point 11 and the method being continued. When the macroscopic powder parameters 12, the chemical components 13 and the initial powder granule structural parameters 14 induce a continuance of the method at process control points 11, a statistically validatable powder representation 5 is drawn from the totality of the powder 2. A solid body 10 is produced therefrom (see FIG. 2). Said solid body 10 is conveyed to a computed tomography apparatus CT and further characteristic values 20 including particle size, particle size distribution, sphericity, form factor distribution, HDP as well as particle surface properties determined by means of computed tomography and output (see FIG. 3 and FIG. 6).

A dispersant 500 is added to the statistically validatable powder representation 5 and the latter is introduced 200a into a liquid precursor stage 17 of a solid body 10 which comprises a first component 300 of a two-component resin to produce 200 a solid body 10 as depicted in FIG. 2. The powder granules 43 of the statistically validatable powder representation 5 are not arranged in a statistically distributed manner in the liquid precursor stage 17 since they bind together by interaction and tend to agglomerate. Although there already are isolated powder granules 44a caused by the dispersant, they are mostly still in the form of agglomerations 44b in the liquid precursor. Moreover, the powder granules 44 are not distributed homogeneously in the liquid precursor stage 17. For this reason, the liquid precursor stage 17 is subjected to application 200b of ultrasound 70 and simultaneously agitated along a main direction of agitation 600. This thereby increases the statistical mean powder granule spacing 18. The application of the ultrasound 70 as well as the agitating along a main direction of agitation 600 ceases once the particles are isolated. Curing 200c of the liquid precursor stage 17 then follows through the addition of a second component of a two-component resin 400. The solid body 10 thereby forms 200d as a result.

The solid body 10 is conveyed to a computed tomography apparatus CT (also see FIG. 1) and, as depicted in FIG. 3, is imaged in a digital volume 100a by means of 3D imaging 30. The solid body 10 is to that end rotated about a rotational axis 19 in one direction of rotation 51 while 2D radiographic X-ray projections 42 are generated along 2D sectional view planes 41 perpendicular 41a to the rotational axis 19 and parallel 41b, 41c to the rotational axis 19. A so-called 2D extraction 40 is therefore conducted. In computed tomography, the absorption differences of sample depth (y) are projected onto the xy-plane. The 2D radiographic X-ray projections 42 thusly extracted contain 2D powder granule projections 45. Subsequently and/or simultaneously, the 2D radiographic X-ray projections 42 to a digital volume 100a along a 3D image synthesis direction 52 which corresponds to the direction of rotation 51 in actual space, are assembled into a 3D image (digital volume). This digital volume 100a contains 3D powder granule representations 46 (3D images of the powder granules). These 3D powder granule representations 46 are thus 3D images of spherical powder granules 80a and aspherical powder granules 80b as well as 3D images of powder granules having a hollow space 80c. A partial digital volume 100b is thereafter selected 60 from partial digital volume 100a and isolated.

FIG. 4a shows a digital volume 100a according to a prior art method. FIG. 4b shows a digital volume 100a according to an inventive method for comparison. Shown for illustrative purposes are 2D radiographic X-ray projections perpendicular 42a to rotational axis 19 as well as 2D radiographic X-ray projections parallel 42b, 42c to rotational axis 19 and a digital volume 100a resulting from the 3D synthesis.

FIG. 5 shows a partial digital volume 100b using the same sample in FIG. 5a, FIG. 5b and FIG. 5c. Starting from FIG. 5a, the partial digital volume 100b reduces through FIG. 5b to FIG. 5c, whereby the particles are shown more clearly and further details become visible such as 3D image representations of isolated spherical powder granules 46a as well as aspherical powder granules 46b. Having information in a digital partial volume 100b allows conclusions to be drawn as to whether powder granules which appear agglomerated 46c are actually isolated or only partially overlap in the image representation due to being arranged on a virtually identical line of sight only in the 2D image representation of the three-dimensional partial digital volume 100b. The particles 46c are therefore also to be identified as isolated particles in the method.

These 3D image representations of the powder granules 80 can subsequently be viewed in isolation 700, as shown in FIG. 6. FIG. 6 shows 2D powder granule projections perpendicular 45a to the rotational axis 19 of the solid body 10 as well as 2D powder granule sectional views parallel 45b, 45c to the rotational axis 19 of the solid body 10. FIG. 6 comparatively shows a 3D image of a spherical powder granule 80a, a 3D image of an aspherical powder granule 80b and a 3D image of powder granule having a hollow space 80c. The characteristic values 20 such as sphericity, surface properties, powder granule length, powder granule diameter, etc. can be educed from these 3D images of the powder granules 80.

FIG. 7 shows a scanning electron micrograph (SEM) of a powder granule 43 of a statistically validatable powder representation after 2D thin-layer preparation. The powder granule 43 exhibits textured/rough surface areas 47 and smooth surface areas as well satellite adhesion 49. Initial powder granule structural parameters 14 are moreover determined, including an initial sphericity, an initial powder granule volume, an initial powder granule length, an initial surface quality, an initial satellite adhesion probability, etc.

FIG. 8 shows a partial digital volume 100b, wherein the dimensioning represents the total diameter of the cylindrical digital volume 100a and the viewing direction corresponds to the rotational axis 19 of the solid body 10.

Preferably, the highest CT resolution is 0.5 μm. This can be continuously increased upwards.

### Cited Non-Patent Literature

Mostafaei et al. 2018 “Comparison of characterization methods for differently atomized nickel-based alloy 625 powders,” Amir Moustafaei, Colleen Hilla, Erica L. Stevens, Peeyush Nandwana, Amy M. Elliot, Markus Chmielus, Powder Technology, 333, 180-192, 2018

It is to be noted at this point that all the above-described components are claimed as essential to the invention on their own and in any combination, in particular the specifics illustrated in the figures. Modifications thereof are familiar to the person skilled in the art.

### LIST OF REFERENCE NUMERALS

1 method for treating and examining a powder by means of instrumental analysis
2 powder totality
3 powder sample, small amount of powder for the powder examination by means of macroscopy and chemical analysis
4 initial small amount
5 statistically validatable powder representation
6 two-dimensional SEM representation
10 solid body
11 process control point
12 macroscopic powder parameters: Hausner factor, degree of corrosion, degree of oxidation
13 chemical components: non-metal content (N, C, O, H), oxide content
14 initial powder granule structural parameters: sphericity, powder granule volume, powder granule length
15 particle size, particle size distribution, sphericity, form factor distribution, HDP, particle surface property
16 purification
17 liquid precursor of solid body
18 powder granule spacing
19 rotational axis
20 characteristic values
30 3D imaging of the solid body
40 2D extraction
41a 2D projection planes, perpendicular to rotational axis
41b, 41c, . . . 2D projection planes, along/parallel to rotational axis
42a 2D radiographic X-ray projections, perpendicular to rotational axis
42b, 42c, . . . 2D radiographic X-ray projections, along/parallel to rotational axis
43 powder granule in statistically validatable powder representation
44 powder granule
44a isolated powder granule
44b powder granule agglomeration
45 2D powder granule projection
45a 2D powder granule projection, perpendicular to rotational axis
45a, 45b, . . . 2D powder granule projection, along/parallel to rotational axis
46 3D powder granule representation=3D powder granule image
46a 3D image of a spherical isolated particle in a partial volume
46b 3D image of an aspherical isolated particle in a partial volume
46c 3D image of two isolated particles albeit on a similar visual axis and therefore partially overlapping
47 rough surface
48 smooth surface
49 satellite
50 3D image synthesis from 2D sectional views
51 solid body direction of rotation
52 2D projection composition for 3D image synthesis
60 selection of partial digital volume from a digital volume
70 ultrasound
80a 3D image of a spherical powder granule
80b 3D image of an aspherical powder granule
80c 3D image of a powder granule with hollow space
100a digital volume of the solid body
100b partial digital volume of a solid body digital volume
200 production of a solid body
200a mixing of a solid body liquid precursor
200b application of ultrasound to solid body liquid precursor
200c curing the liquid precursor into a solid body
200d completion of solid body curing
300 first component of a two-component resin
400 second component of a two-component resin
500 dispersant
600 main direction of agitation of an agitating means
700 isolated view of 3D image representations of powder granules for determining further characteristic values
Macroscopy piling behavior analysis
Chem. Ana. chemical analysis
SEM scanning electron microscopy
CT computed tomography

1-33. (canceled)

34. A method for treating and examining a powder comprising:
introducing powder granules of the powder into a liquid precursor stage of a solid body, wherein the powder granules are arranged in the solid body as a statistically validatable powder representation of the powder granules of the powder;
isolating and distancing the powder granules of the statistically validatable powder representation from surrounding powder granules of the statistically validatable powder representation and homogeneously distributed in the precursor stage by isolating the introduced powder granules using one or more of dispersants, surfactants, ultrasound, mechanical agitation, and stirring;
fixing a position of the isolated powder granules of the statistically validatable powder representation by one of transitioning and converting of the precursor stage of the solid body having the isolated powder granules distanced from the surrounding powder granules of the statistically validatable powder representation and homogeneously distributed in the precursor stage, into the solid body;
graphically representing the solid body via a computed tomographic representation; and
determining and outputting at least one characteristic value of the statistically validatable powder representation of the powder granules by evaluating the computed tomographic representation of the solid body.

35. The method according to claim 34, wherein at least one step of the method is repeated.

36. The method according to claim 34, wherein the statistically validatable powder representation includes sampling at least 100 powder granules and no more than 10,000,000 powder granules.

37. The method according to claim 34, wherein the at least one characteristic value is one of a volume, a surface area and a length.

38. The method according to claim 34, wherein the computed tomographic representation includes creation of a digital volume of the solid body.

39. The method according to claim 34, further comprising extracting impurities from the powder and examining one or more of the extracted impurities of the powder and remaining purified powder by weighing and by scanning electron microscopy examination.

40. The method according to claim 39, further comprising examining the extracted impurities as per one of the examination applied to the powder, parts of the examination applied to the powder, and one part of the examination applied to the powder, and at least a part of at least one of the examination applied to the powder by two-dimensional tomographic representation, whereby purification parameters can be determined.

41. The method according to claim 34, further comprising determining at least one macroscopic powder parameter selected from one or more of piling behavior, coloration of the powder, and a chemical component of the powder.

42. The method according to claim 34, further comprising:
generating at least one two-dimensional tomographic representation of an initial small amount of powder granules of the powder; and
determining and outputting at least one powder granule structural parameter based on the at least one two-dimensional tomographic representation, wherein the powder granule structural parameter is used to adjust a sample position for one or more of an imaging parameter and an image recording setting of the computed tomographic representation of the solid body.

43. The method according to claim 42, wherein the at least one powder granule structural parameter is an absorption behavior and at least one 3D imaging parameter is a source setting.

44. The method according to claim 42, wherein the at least one powder granule structural parameter is a particle size of the powder granules and at least one 3D imaging parameter is a detection resolution.

45. The method according to claim 42, wherein the at least one two-dimensional tomographic representation includes at least one magnified image representation of the powder granules of the initial small amount of powder granules.

46. The method according to claim 45, wherein one or more of form parameters and state parameters of the powder granules are obtained as the initial powder granule structural parameter based on the at least one magnified image representation.

47. The method according to claim 34, wherein ultrasound acts upon at least one precursor stage of the solid body during a production of the solid body.

48. The method according to claim 47, wherein the ultrasound acting upon the at least one precursor stage of the solid body occurs during which the at least one precursor stage is forming into the solid body.

49. A method for treating and examining a powder comprising:
introducing powder granules of the powder into a liquid precursor stage of a solid body, wherein the powder granules are arranged in the solid body as a statistically validatable powder representation of the powder granules of the powder, wherein the statistically validatable powder representation includes sampling at least 100 powder granules and no more than 10,000,000 powder granules;
isolating and distancing the powder granules of the statistically validatable powder representation from surrounding powder granules of the statistically validatable powder representation and homogeneously distributed in the precursor stage by isolating the introduced powder granules using one or more of dispersants, surfactants, ultrasound, mechanical agitation, and stirring, wherein during a production of the solid body ultrasound acts upon the precursor stage of the solid body;
fixing a position of the isolated powder granules of the statistically validatable powder representation by one of transitioning and converting of the precursor stage of the solid body having the isolated powder granules distanced from the surrounding powder granules of the statistically validatable powder representation and homogeneously distributed in the precursor stage, into the solid body;
graphically representing the solid body via a computed tomographic representation; and
determining and outputting at least one characteristic value of the statistically validatable powder representation of the powder granules by evaluating the computed tomographic representation of the solid body.

50. The method according to claim 49, wherein a two-dimensional tomographic representation of an initial powder granule structural parameter includes at least one magnified image representation of the powder granules of an initial small amount of powder granules.

51. The method according to claim 50, wherein one or more of form parameters and state parameters of the powder granules are obtained as the initial powder granule structural parameter based on the at least one magnified image representation.

52. The method according to claim 49, further comprising extracting impurities from the powder and examining one or more of the extracted impurities of the powder and remaining purified powder by weighing and by scanning electron microscopy examination.

53. A method for treating and examining a powder comprising:
introducing powder granules of the powder into a liquid precursor stage of a solid body, wherein the powder granules are arranged in the solid body as a statistically validatable powder representation of the powder granules of the powder;
isolating and distancing the powder granules of the statistically validatable powder representation from surrounding powder granules of the statistically validatable powder representation and homogeneously distributed in the precursor stage by isolating the introduced powder granules using one or more of dispersants, surfactants, ultrasound, mechanical agitation, and stirring;
fixing a position of the isolated powder granules of the statistically validatable powder representation by one of transitioning and converting of the precursor stage of the solid body having the isolated powder granules distanced from the surrounding powder granules of the statistically validatable powder representation and homogeneously distributed in the precursor stage, into the solid body;
graphically representing the solid body via a computed tomographic representation;
extracting impurities from the powder and examining one or more of the extracted impurities of the powder and remaining purified powder by weighing and by scanning electron microscopy examination; and
determining and outputting at least one characteristic value of the statistically validatable powder representation of the powder granules by evaluating the computed tomographic representation of the solid body.
